(19) United States
(12) Patent Application Publication
(10) Pub. No.: US 2011/0310789 A1
(43) Pub. Date: Dec. 22, 2011

(54) METHOD OF UPLINK CONTROL CHANNEL ALLOCATION FOR A RELAY BACKHAUL LINK

(76) Inventors: Teck Hu, Melbourne, FL (US); Matthew Baker, (US); Fang-Chen Cheng, Murray Hill, NJ (US)

(21) Appl. No.: 13/042,797

(22) Filed: Mar. 8, 2011

Related U.S. Application Data
(60) Provisional application No. 61/356,897, filed on Jun. 21, 2010.

(51) Int. Cl. H04W 72/04; H04B 7/14

(52) U.S. Cl. 370/315

(57) ABSTRACT

The present invention provides a method for uplink control channel allocation for a relay backhaul link. Embodiments of the method include allocating resource blocks in a subframe for a backhaul downlink control channel between an access node and a relay station. The resource blocks are allocated from a first portion of the subframe that is different than a second portion of the subframe allocated to a downlink control channel between the relay station and at least one access terminal. Embodiments of the method also include transmitting control information from the access node in the resource blocks.

### CROSS REFERENCE TO RELATED APPLICATIONS

This application claims priority to U.S. Provisional Patent Application 61/356,897 filed on Jun. 21, 2010.

### BACKGROUND OF THE INVENTION

1. Field of the Invention

This invention relates generally to communication systems, and, more particularly, to wireless communication systems.

2. Description of the Related Art

Wireless communication systems provide wireless connectivity to access terminals using a network of interconnected access nodes such as eNodeBs or base stations. Communication over the air interface between the access terminals and the base stations take place according to various agreed-upon standards and/or protocols. For example, the Third Generation Partnership Project (3GPP, 3GPP2) has specified a set of standards for a packet-switched wireless communication system referred to as Long Term Evolution (LTE). The LTE standards support access schemes including single-carrier frequency division multiple access (SC-FDMA). Multiple users can concurrently access the SC-FDMA network using different sets of non-overlapping Fourier-coefficients or sub-carriers. One distinguishing feature of SC-FDMA is that it leads to a single-component carrier transmit signal. The LTE standards also support multiple-input/multiple-output (MIMO) communication over the air interface using multiple antennas deployed at transmitters and/or receivers. The carrier bandwidth supported by LTE is approximately 20 MHz, which can support a downlink peak data rate of approximately 100 Mbps and a peak data rate of the uplink of approximately 50 Mbps.

Relays can be used to extend the range of the access nodes. For example, wireless communication systems that operate according to the LTE standards can implement Type-1 relays that can be used to establish communication between an access node and access terminals that are located beyond the typical range of the access node. The communication link between the access node and the access terminal includes a backhaul link between the access node and the relay and access links between the relay and each access terminal. A Type-1 relay transmits common reference signals and control information from the access node to support communication with each access terminal. Type-1 relays typically reuse two independent HARQ procedures: one to support communication between the access node and the relay node and another to support communication between the relay nodes and access terminal(s). Type-1 relays have an independent cell identifier and this type of relay provides resource scheduling and hybrid automatic repeat request (HARQ) retransmission functionality.

### SUMMARY OF EMBODIMENTS OF THE INVENTION

The disclosed subject matter is directed to addressing the effects of one or more of the problems set forth above. The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In one embodiment, a method is provided for uplink control channel allocation for a relay backhaul link. Embodiments of the method include allocating resource blocks in a subframe for a backhaul downlink control channel between an access node and a relay station. The resource blocks are allocated from a first portion of the subframe that is different than a second portion of the subframe allocated to a downlink control channel between the relay station and at least one access terminal. Embodiments of the method also include transmitting control information from the access node in the resource blocks.

In another embodiment, a method is provided for uplink control channel allocation for a relay backhaul link. Embodiments of the method include conveying control information over a backhaul interface between an access node and a relay station concurrently with the relay station transmitting a subframe that does not include a common reference signal. The control information is conveyed using resource blocks that are different than resource blocks allocated for transmission of control information by the relay station in the subframe.

In yet another embodiment, a method is provided for uplink control channel allocation for a relay backhaul link. Embodiments of the method include generating control information including a scheduling grant in response to receiving a request from a relay station to transmit backhaul information associated with one or more access terminals. The method also includes configuring a first subframe for transmission of the control information concurrently with the relay station configuring a second subframe that does not include a common reference signal for transmission over an interface between the relay station and at least one access terminal. The method further includes transmitting the first subframe concurrently with the relay station transmitting the second subframe. Resource blocks are allocated for the control information from a first portion of the first subframe that is different than a second portion of the second subframe allocated to a downlink control channel between the relay station and the access terminal(s).

In a further embodiment, a method is provided for uplink control channel allocation for a relay backhaul link. Embodiments of the method include configuring a first subframe that does not include a common reference signal for transmission over an interface between a relay station and one or more access terminals. The method also includes transmitting the first subframe concurrently with receiving a second subframe from an access node in response to the relay station transmitting a request to transmit backhaul information associated with the access terminal(s). Transmitting the first subframe includes bypassing transmission in resource blocks that are allocated for transmission of control information in the second subframe. The control information includes a scheduling grant formed in response to the request to transmit backhaul information.

### BRIEF DESCRIPTION OF THE DRAWINGS

The disclosed subject matter may be understood by reference to the following description taken in conjunction with the accompanying drawings, in which like reference numerals identify like elements, and in which:

FIG. 1 conceptually illustrates one exemplary embodiment of a wireless communication system;

FIG. 2 conceptually illustrates one exemplary embodiment of an uplink component carrier that may be used for single carrier frequency division multiple access (SC-FDMA) communication over an air interface;

FIG. 3 conceptually illustrates a timing diagram including several subframes;

FIG. 4A conceptually illustrates one exemplary embodiment of a conventional subframe;

FIG. 4B conceptually illustrates one exemplary embodiment of a subframe that is configured to transmit control information over a backhaul link to a relay station concurrently with transmission of an MBSFN subframe by the relay station; and

FIG. 5 conceptually illustrates one exemplary embodiment of a method of providing control signaling and feedback over an interface between a relay station and the access node.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the scope of the appended claims.

### DETAILED DESCRIPTION OF SPECIFIC EMBODIMENTS

Illustrative embodiments are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The disclosed subject matter will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

Generally, the present application describes embodiments of techniques that can be used to allocate uplink control channels to a wireless backhaul link between an access node and a relay station that supports wireless communication with one or more access terminals over one or more access links. The air interface between the access node and the relay station typically shares a pre-determined frequency space with the air interfaces between access terminals and the relay station. Operation of the access node and the relay station should therefore be coordinated to reduce or avoid interference between signals transmitted over the two air interfaces. For example, relay stations (such as a Type 1 Relay node) should not transmit and receive signals at the same time in the same frequency bands. Moreover, communication over the backhaul link should be consistent with standards for communication over an air interface between an access terminal and an access node. In one embodiment, these requirements can be met by performing backhaul communication while the relay transmits a Multicast/Broadcast Multimedia Services (MBMS) Single Frequency Network (MBSFN) subframe towards the access terminals. However, the first one or two symbols of the MBSFN subframe may be reserved for Physical Downlink Control Channel (PDCCH) transmissions to the access terminals. These symbols may therefore not be available to support a control channel for the backhaul link. Furthermore, since these channels are not available to support the backhaul link control channel, existing uplnk resource allocation of HARQ protocols cannot be used for the backhaul link since they assume that control channel information (such as scheduling grants) are transmitted in the symbols that are reserved for the access link downlink control channel.

At least in part to address these drawbacks in the conventional practice, the present application describes embodiments of a communication system that may allocate resource blocks for a backhaul downlink control channel (which may be referred to as a Relay Physical Downlink Control Channel, R-PDCCH) from a first portion of a subframe that is different than a second portion of the subframe that is reserved for the access link downlink control channel. Acknowledgment feedback can then be returned over the uplink in response to signaling transmitted over the allocated resource blocks. In one embodiment, control information may be transmitted over the backhaul downlink control channel concurrently with the relay station transmitting a subframe that does not include a common reference signal over the access link. For example, backhaul signals may be conveyed between relay stations and access nodes concurrently with the relay station transmitting a MBMS single frequency network (MBSFN) subframe towards access terminals while the relay station bypasses transmission of the reference signal in the MBSFN subframe. The control signaling for the backhaul link may also be transmitted to the relay station using resource blocks that are different than the resource blocks allocated for transmission of control information towards the access terminals in the MBSFN subframe. The relay station can transmit acknowledgment feedback to the access node in a predetermined subsequent subframe.

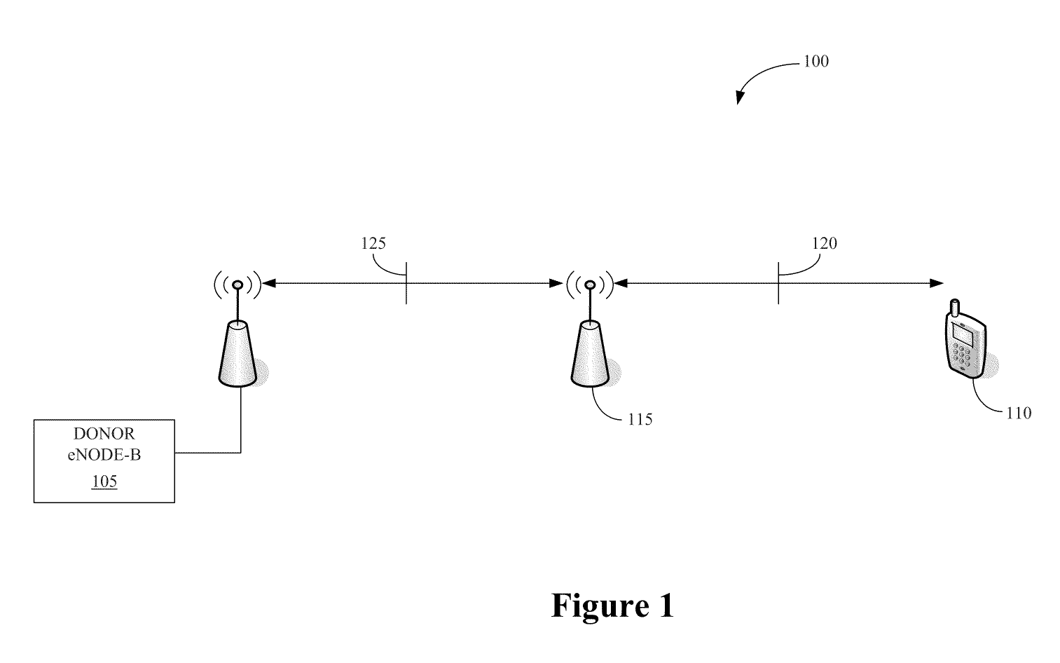

FIG. 1 conceptually illustrates one exemplary embodiment of a wireless communication system 100. In the illustrated embodiment, the wireless communication system 100 includes one or more access nodes 105 such as base stations or eNodeBs that are used to provide wireless connectivity to one or more access terminals 110, which may also be referred to as subscriber terminals, subscriber stations, mobile units, mobile nodes, fixed wireless devices, and the like. The wireless communication system 100 may operate according to the standards and/or protocols defined for the Long Term Evolution (LTE) of the Universal Mobile Telecommunications System (UMTS). Systems that operate according to LTE are intended to provide high peak data rates (e.g., 100 Mb per second on the downlink and 50 Mb per second on the uplink), low latency (e.g., 10 ms round-trip delays), multi-antenna support, bandwidths of up to 20 MHz, and the like. However, persons of ordinary skill in the art having benefit of the present disclosure should appreciate that alternative embodiments of the wireless communication system 100 may operate according to different standards and/or protocols that meet different system goals. For example, embodiments of the techniques described herein may also be applied to systems that operate according to LTE-Advanced.

The wireless communication system 100 also includes one or more relay stations 115 that can be used to relay signals transmitted between the access node 105 and one or more access terminals 110. The relay station 115 may therefore be used to extend the range of the access node 105 to provide services to access terminals 110 at comparatively large distances from the access node 105, e.g., at distances beyond the cell size defined by the pilot signal strength transmitted by the access node 105. In the illustrated embodiment, the relay station 115 is a Type-1 relay that transmits common reference signals and control information from the access node 105 to support communication with each access terminal 115. The relay station 115 may use a selective decode and forward transmission scheme in which the relay station 115 performs channel decoding of the data and/or control signaling received from the access node 105 or access terminal 110, performs error checking, and then forwards the signal to the access terminal 110 or access node 105. The relay station 115 may have an independent cell identifier and in the illustrated embodiment the relay station 115 provides resource scheduling and hybrid automatic repeat request (HARD) retransmission functionality.

The relay station 115 communicates with the access terminal 110 over an air interface 120. In the illustrated embodiment, the air interface 120 is established according to the LTE standards and/or protocols that are used to establish air interfaces between eNodeBs and access terminals 110. The air interface 120 may therefore be referred to as a Uu interface. Downlink transmissions over the Uu interface 120 may use orthogonal frequency division multiplexing (OFDM) in accordance with LTE standards. Downlink reference signals may be transmitted in selected symbols of the downlink subframes. The downlink reference signal can be used for channel estimation, channel quality information (CQI) measurement, and cell search/acquisition. In one embodiment, the wireless communication system 100 may use OFDM to enable broadcast services on a synchronized single frequency network (SFN). For example, multicast/broadcast multimedia services (MBMS) can be provided using single cell broadcasts and/or MBSFN techniques. During MBSFN operation, a time-synchronized set of base stations (which may include the base station 105 and/or the relay station 115) transmit the signals for the MBMS service using the same resource block. A common reference signal can be used by the time-synchronized set of base stations to support demodulation of the channel.

Uplink transmissions over the Uu interface 120 may use single-carrier frequency division multiple access (SC-FDMA) in accordance with the LTE standards. Control signaling and/or sounding reference signals may be used for channel quality estimation. The reference signals may be frequency domain multiplexed onto a distinct set of subcarriers to maintain orthogonality of the reference signals.

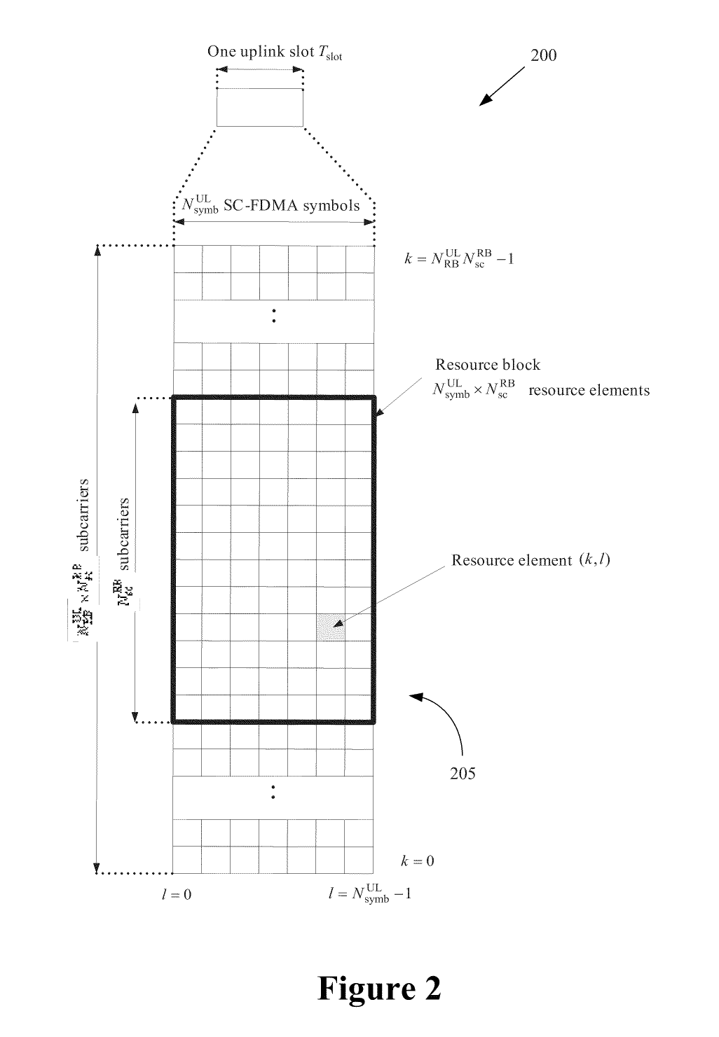

FIG. 2 conceptually illustrates one exemplary embodiment of an uplink component carrier that may be used for single carrier frequency division multiple access (SC-FDMA) communication over an air interface. Embodiments of structures such as the structure of the component carrier 200 depicted in FIG. 2 may also be used for other component carriers such as the multiple component carriers supported by LTE-Advanced compliant systems. In one embodiment, the component carrier 200 is temporally divided into frames that are further temporally subdivided into subframes. Each subframe includes two timeslots. FIG. 2 depicts one exemplary uplink time slot, Tₛₗₒₜ. The transmitted signal in each slot is described by one or several resource grids 205 of subcarriers and N_{RB}^{UL}N_{sc}^{RB} subcarriers and N_{symb}^{UL} SC-FDMA symbols. The quantity N_{RB}^{UL} depends on the uplink transmission bandwidth configured in the cell and in embodiments that conform to the 3GPP standards, the quantity fulfils the condition:

N_{RB}^{min,UL}≦N_{RB}^{UL}≦N_{RB}^{max,UL}

where N_{RB}^{min,UL}=6 and N_{RB}^{max,UL}=110 are the smallest and largest uplink bandwidths, respectively, supported by the current version of the specification. The number of SC-FDMA symbols in a slot may depend on the cyclic prefix length configured by a higher layer parameter UL-CyclicPrefixLength.

Each element in the resource grid 205 may be referred to as a resource element and can be uniquely defined by the index pair (k,l) in a slot where k=0, . . . , N_{RB}^{UL}N_{sc}^{RB}−1 and l=0, . . . , N_{symb}^{UL}−1 are the indices in the frequency and time domains, respectively. Resource element (k,l) on antenna port p corresponds to the complex value a_{k,l}^{(p)}. When there is no risk for confusion, or no particular antenna port is specified, the index p may be dropped. Quantities a_{k,l}^{(p)} corresponding to resource elements not used for transmission of a physical channel or a physical signal in a slot may be set to zero. A physical resource block may be defined as N_{symb}^{UL} consecutive SC-FDMA symbols in the time domain and N_{sc}^{RB} consecutive subcarriers in the frequency domain. Exemplary values of N_{symb}^{UL} and N_{sc}^{RB} given by Table 1. In the illustrated embodiment, a physical resource block in the uplink consists of N_{symb}^{UL}×N_{sc}^{RB} resource elements, corresponding to one slot in the time domain and 180 kHz in the frequency domain.

TABLE 1
Exemplary resource block parameters.

| Configuration | N_{sc}^{RB} | N_{symb}^{UL} |
|---|---|---|
| Normal cyclic prefix | 12 | 7 |
| Extended cyclic prefix | 12 | 6 |

The relation between the physical resource block number n_{PRB} in the frequency domain and resource elements (k,l) in a slot may be given by the formula:

$${n}_{PRB} = ⌊ \frac{k}{{N}_{sc}^{RB}} ⌋$$

Referring back to FIG. 1, the relay station 115 communicates with the access node 105 over an air interface 125. Backhaul information including data and/or control signaling may be conveyed over the air interface 125 in subframes of the interface. The air interface 125 may be referred to as a backhaul link and/or a Un interface. In the illustrated embodiment, subframes of the air interface 125 may be configured using radio resource control (RRC) signaling from the access node 105, which may be referred to as a donor eNodeB. Configuration of the subframes includes initial subframe configuration and subsequent reconfiguration of the subframes. The Un subframe allocation may be part of the radio resource management (RRM) responsibilities and/or functionality implemented by the access node 105. The control signaling for the Un subframe configuration may be performed using RRC signaling between the access node 105 and/or the relay station 115. The air interface 125 also supports retransmission schemes such as hybrid automatic repeat request (HARQ) schemes and in the illustrated embodiment the HARQ timing is associated with the Un subframe allocation.

In the illustrated embodiment, RRC signaling is transmitted to the relay station 115 over the backhaul link 125 to configure the Un radio resources, the procedures, and the system parameters. For example, the RRC signaling can be sent when the relay station 115 is in the user equipment (UE) mode. For Type 1 relay, the backhaul (Un) link 125 shares time and frequency resources with the access links 120 for the access terminals 110 that are under the coverage of the access node 105. The Un interface design and system configuration should therefore be consistent with the design and configuration of the Uu interface 120. At least in part to avoid interference, the relay station 115 should not transmit signals on the backhaul link 125 while concurrently receiving signals using the same resources on the access link 120. The relay station 115 also should not receive signals on the backhaul link 125 while concurrently transmitting signals using the same resources on the access link 120.

Flexible Un subframe allocation may be used allow the access node 105 to manage interference for the access link 120. The access node 105 could allocate different Un subframes to different relay stations that are served by the same donor access node (e.g., the access node 105) to minimize the inter-relay interference in the corresponding access links. In some cases, the Un DL subframe allocation may be constrained by the condition that the MBSFN subframe for the access link 120 also should be configured for the same (or overlapping) time. The Un DL subframe reconfigurations may therefore be coordinated with the MBSFN reconfiguration in the access link. There is not expected to be an MBSFN subframe restriction for Un UL subframe. Thus, the access node 105 may have more flexibility to reconfigure the Un UL subframe to get more efficient interference management.

Downlink control signals may be transmitted over the backhaul link 125 to the relay station 115 during a time interval when the relay station 115 is not transmitting on the access link 120. In one embodiment, the access node 105 may configure a subframe for transmission over the backhaul link 125 that includes a downlink control channel and the relay station 115 may configure a subframe for transmission over the access link 120 that bypasses transmission for at least a portion of the subframe so that no information is transmitted during this portion of the subframe and does not interfere with transmission over the backhaul link 125. For example, the relay station 115 may bypass transmission of data, multicast/broadcast services, reference signals, and perhaps other information during a portion of the subframe. The relay station 115 therefore generates and transmits substantially no signal energy in this portion of the subframe. The access node 105 and the relay station 115 can then transmit their corresponding subframes during the same time interval.

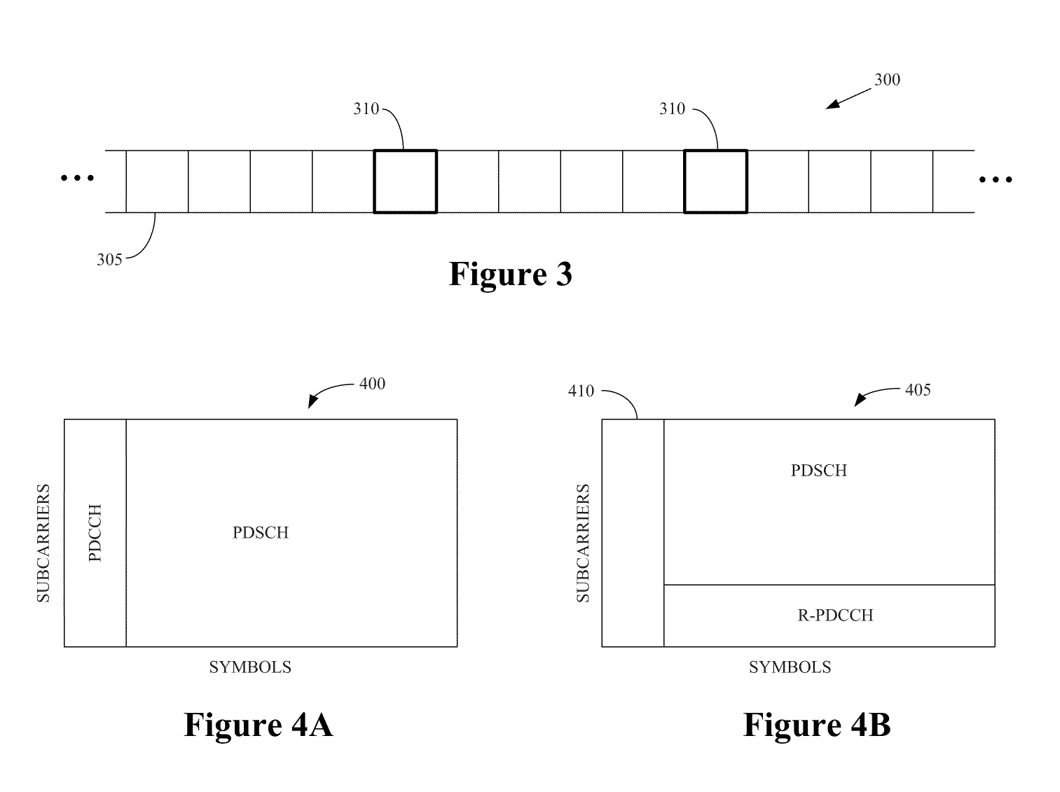

FIG. 3 conceptually illustrates a timing diagram 300 including several subframes 305, 310. In the illustrated embodiment, the subframes 305 are used by a relay station to communicate with one or more access terminals over corresponding access links. Backhaul transmissions do not take place between the relay station and an access node during the subframes 305 to reduce or avoid interference. The relay station can configure the subframes 310 as MBSFN subframes and then bypass transmission during a portion of the MBSFN subframe that is typically used to convey information and/or signaling for a multicast/broadcast service. MBSFN reference signals may only be transmitted only when the Physical Multicast Channel (PMCH) is transmitted and a common reference signal may not be transmitted when the relay station bypasses transmission during portions of the MBSFN subframe. The mobile node can assume that no cell-specific reference signal is being sent during this portion of the MBSFN subframe. The access node can configure subframes 310 for transmission over the backhaul link so that control information is conveyed to the relay station concurrently with the portions of the MBSFN subframe that are bypassed by the relay station.

FIG. 4A conceptually illustrates one exemplary embodiment of a conventional subframe 400. In the illustrated embodiment, the subframe 400 includes a plurality of subcarriers distributed across the frequency bandwidth of the subframe 400 and a plurality of symbols. The subframe 400 supports channels including a physical downlink control channel (PDCCH) that is typically used to convey control signaling such as scheduling grants and a physical downlink shared channel (PDSCH) that is typically used to convey data. The first few symbols of the subframe 400 are reserved for the PDCCH. For example, the LTE standards dictate that the first 2 or 3 symbols in a normal subframe and the first 1 or 2 symbols of an MBSFN subframe must be reserved on all of the subcarriers for the PDCCH. The remaining symbols can be allocated to a shared channel on a frequency division multiplexed (FDM) basis so that different subcarriers can be allocated independently.

FIG. 4B conceptually illustrates one exemplary embodiment of a subframe 405 that is configured to transmit control information over a backhaul link to a relay station concurrently with transmission of an MBSFN subframe by the relay station. In the illustrated embodiment, the subframe 405 includes a plurality of subcarriers distributed across the frequency bandwidth of the subframe 405 and a plurality of symbols. As discussed herein, an MBSFN subframe reserves the first few symbols of the subframe for transmitting control information such as a PDCCH. Consequently, the MBSFN subframe transmitted by the relay station includes signaling in the first few symbols that can potentially interfere with transmissions over the backhaul link in the same symbols. The subframe 405 may therefore be configured to bypass transmission in the symbols 410 of the subframe 405 that correspond to the PDCCH symbols in the MBSFN subframe. The remaining symbols of the subframe 405 can be used to convey information including control signaling (e.g., uplink scheduling grants) for the backhaul link concurrently with the relay station bypassing transmission in the symbols that are not reserved for the PDCCH. The subframe 405 may therefore be configured to include an FDM downlink control channel that is referred to herein as the R-PDCCH. In the illustrated embodiment, the R-PDCCH is frequency multiplexed with the PDSCH. The particular subcarriers or distribution of subcarriers allocated to the R-PDCCH is a matter of design choice.

Referring back to FIG. 1, an alternate method for allocating the uplink control channel on the backhaul link may be used in conjunction with the R-PDCCH. Since the relay station 115 does not receive control signaling such as downlink scheduling grants over the PDCCH, resource blocks can be allocated for uplink control signaling in a static, semi-static, and/or dynamic fashion. Exemplary uplink control channel signaling may include acknowledgement messages and the like. In various embodiments, the physical uplink control channel (PUCCH) can support symmetrical (one-to-one) and/or asymmetrical (many-to-one) DL/UL subframe allocation cases. The Un PUCCH channel resource allocation can be configured to avoid the collision with the autonomous PUCCH channel allocation mechanism used by access terminals that are under the coverage of the access node 115.

Static allocation of the uplink control channels can be performed by a pre-allocating a group of PUCCH channels for use by the relay station 115. A fixed channel index is used to indicate the channel that is allocated to each relay node. Embodiments of this technique may be relatively simple and straight forward to implement at least in part because the relay backhaul link 125 would likely have substantially constant Un DL data traffic and control signaling. A static PUCCH resource allocation can be configured to provide sufficient resources to ensure proper DL HARQ operation. Semi-static allocation may be implemented by using values of power control bits on the downlink control channel (which are not used for power control by the relay station 115) and higher layer signaling to indicate the resource block allocation for the uplink control channel. In one embodiment, the PUCCH allocation could reuse previously established PUCCH assignments for DL semi-persistent scheduling though higher layer configuration and an appropriate index table when PDCCH is not presented. Dynamic allocation may be implemented by allocating uplink channel resources based on the physical resource block (PRB) index of the R-PDCCH. For example, the R-PDCCH can have an FDM structure with DL grant in the 1^{st} slot and UL grant in the 2^{nd} slot. A group of PUCCH channels could be pre-configured for the relay station 115 to avoid collision with those PUCCH channels used by the access terminal 110 that is under coverage of the access node 105. The relay station 115 could use a combination of the PRB index and the first control channel element (CCE) of the specific PRB of the R-DPCCH to determine the n_{CCE} value of n_{PUCCH}⁽¹⁾=n_{CCE}+N_{PUCCH}⁽¹⁾ with N_{PUCCH}⁽¹⁾ being configured by higher layers.

The relay station 115 and transmit (or retransmit) information associated with the HARQ process indicated in each scheduling grant received over the R-PDCCH. In one embodiment, the HARQ process for relay backhaul link may be consistent with operation of HARQ processes on the access link 120 of the access node 105. For example, the HARQ processes may implement adaptive HARQ for the downlink and synchronous HARQ for the uplink process. In embodiments that do not implement a Physical HARQ Indicator Channel (PHICH) in the backhaul link, the UL HARQ process could be adaptive with retransmission based on the UL grant. The new data indicator (NDI) value in the UL grant may provide implicit ACK/NAK indication for the on-going HARQ process. In order to support Un synchronous HARQ operation, the initial transmission for each HARQ process ID may be based on an UL grant. The relay node 115 may then perform UL retransmission at the same resource allocation of initial transmission for the specific HARQ process ID at next available UL subframe that is 8 ms or later under the conditions: (1) a new UL grant is received with new data indication in the NDI field and/or (2) the maximum number of allowed retransmissions has been reached. The relay node 115 may also perform UL retransmission at new resource blocks if a new UL grant is received with new resource allocation. The relay node 115 would stop UL transmission or retransmission if a new UL grant is received with new data indication in the NDI field and its buffer is empty. In one embodiment, operation of the Un uplink HARQ process is synchronous with implicit acknowledgment feedback for retransmissions.

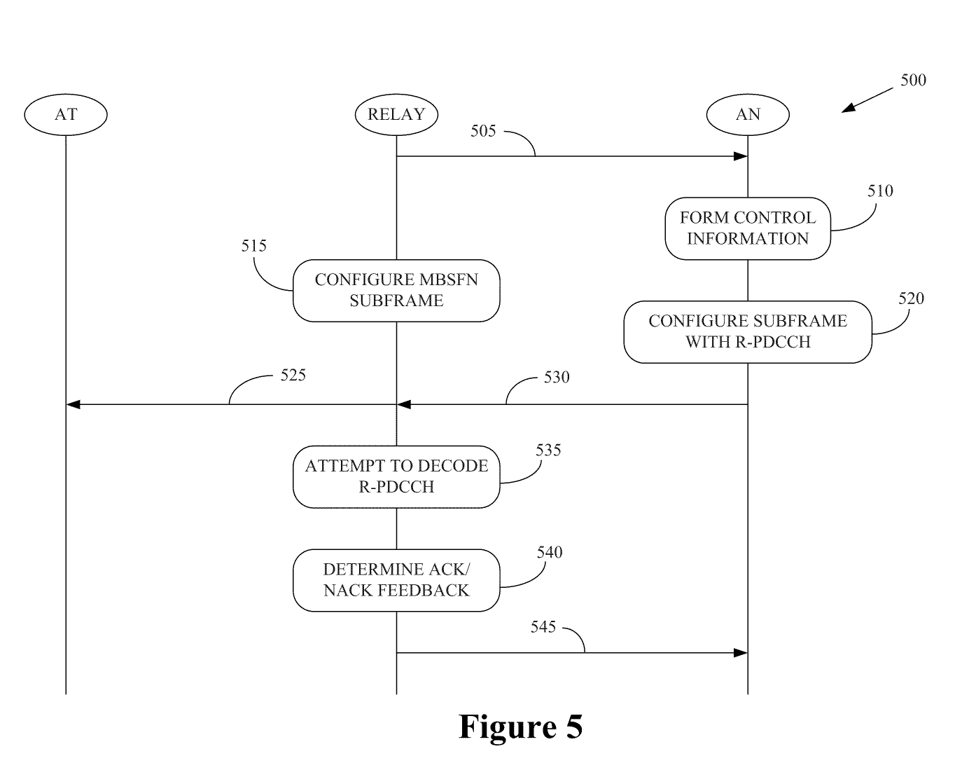

FIG. 5 conceptually illustrates one exemplary embodiment of a method 500 of providing control signaling and feedback over an interface between a relay station (RELAY) and the access node (AN). In the illustrated embodiment, the relay station is used to convey signals between the access node and one or more access terminals (AT) over corresponding air interfaces. The method 500 begins in response to the access node receiving (at 505) a request from the relay station to transmit backhaul data for one or more access terminals on the uplink of the backhaul link between the relay station and the access node. The access node creates (at 510) control information in response to receiving (at 505) the request. The control information includes a scheduling grant that indicates resources that are allocated for the requested transmission over the uplink. To avoid collisions and/or interference between the information transmitted by the relay station and received by the relay station, communication over the backhaul link and the access link is coordinated.

In the illustrated embodiment, the relay station prepares to transmit a subframe that includes an empty portion while the access node prepares to concurrently transmit control information to the relay station. For example, the relay station configures (at 515) an MBSFN subframe for transmission over the Uu interface between the relay station and the access terminal served by the relay station. As discussed herein, one portion of the MBSFN subframe is used to transmit control information over the Uu interface and the relay station can bypass transmission during another portion of the MBSFN. Consequently, the relay station creates substantially no signal energy to interfere with received signals during the bypass portion of the MBFSN. The access node configures (at 520) a normal subframe for transmission over the Un interface between the access node (eNB) and the relay station. The subframe can be configured (at 520) to transmit control information in resource blocks that correspond to the portion of the MBSFN subframe that is not being used to transmit signals from the relay station. Persons of ordinary skill in the art having benefit of the present disclosure should appreciate that configuration (at 515, 520) of the subframes can occur in any order and/or concurrently.

The relay station and the access node can concurrently transmit (at 525, 530) the MBSFN subframe and the normal subframe, respectively. In the illustrated embodiment, the MBSFN subframe and the normal subframe are transmitted during a selected time interval that corresponds to a subframe in the temporal structure of the air interfaces. Persons of ordinary skill in the art should appreciate that the term “subframe” may be used to refer to both the time intervals in the air interface channel structure and the information that is transmitted in these time intervals. The relay station may attempt (at 535) to demodulate and/or decode the information transmitted over the backhaul link including the control information transmitted in the R-PDCCH. Acknowledgment feedback can then be determined (at 540) based on the results of the attempt to demodulate and/or decode the received information. If the relay station successfully demodulates and/or decodes (at 535) the information, then the relay station may determine (at 540) that a positive acknowledgment (ACK) should be sent. If the relay station was not able to successfully demodulate and/or decode (at 535) the received information, then the relay station may determine (at 540) that a negative acknowledgment (NACK) should be sent.

The relay station transmits (at 545) the acknowledgment feedback to the access node to indicate success or failure in demodulating and/or decoding the received information. In various embodiments, the acknowledgment feedback may be transmitted over the backhaul uplink using a static allocation of resource blocks, a semi-static allocation indicated by power control bits transmitted over the backhaul downlink, or dynamic allocation based on the resource block indices of the control information transmitted over the R-PDCCH. The access node may attempt to retransmit the control information when it receives a negative acknowledgment. Alternatively, the relay station and the access node can proceed with transmission of the requested data in the allocated resources if the access node receives a positive acknowledgment.

One or more subframes can be allocated for the requested UL transmission after receiving the UL scheduling grant over the R-PDCCH. The timeline of LTE UL transmission for FDD system is 4 ms after receiving the UL scheduling grant from PDCCH. In TDD, the UL transmission takes places at the 1st subframe k ms later, where k greater than or equal to 4, after receiving the UL scheduling grant over the PDCCH. In one embodiment, the HARQ timeline for the Un UL backhaul link may follow the principle defined in LTE TDD system and transmit at the 1st frame that is k ms after reception of the scheduling grant, where k is greater than or equal to 4. The value of k may be derived when the DL/UL subframe allocations are configured through RRC, as discussed herein. Embodiments of this approach may be used for the Un backhaul link in FDD or TDD systems.

Configuration of the Un subframe may also be based on the processing timeline of the HARQ process. For example, as discussed herein, a Type 1 relay node should not concurrently transmit in the Un backhaul link and receive in the Uu access link or concurrently receive in the Un backhaul link and transmit in the Uu access link. In one embodiment, DL HARQ may be adaptive and require a DL grant for retransmission. Thus, the DL HARQ operation of the Un interface may be consistent with the protocols defined by Rel-8/9 LTE. For UL HARQ, retransmission may be autonomous with 8 ms round-trip time (RTT). However, in some cases the Un UL subframes are not configured continuously and so the subframe for retransmission of a given HARQ process ID might not be exactly 8 ms later. In one embodiment, retransmission may therefore occur at the next available UL subframe at 8 ms or later. To support UL synchronous HARQ, the HARQ timeline can be slightly adjusted since the UL subframe allocation might not occur at precise 8 ms intervals. In order to support UL synchronous HARQ operation in the Un interface, the time of UL retransmission may be adjusted to next available UL subframe 8 ms or later, which is similar to TDD HARQ procedure.

Portions of the disclosed subject matter and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the disclosed subject matter are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The disclosed subject matter is not limited by these aspects of any given implementation.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed:

1. A method, comprising:
allocating, at an access node, resource blocks in a subframe for a backhaul downlink control channel between the access node and a relay station, wherein the resource blocks are allocated from a first portion of the subframe that is different than a second portion of the subframe allocated to a downlink control channel between the relay station and at least one access terminal; and
transmitting control information from the access node in the resource blocks.

2. The method of claim 1, wherein the second portion of the subframe comprises a selected number of symbols at the beginning of the subframe, and wherein allocating resource blocks from the first portion of the subframe comprises allocating symbols following the selected number of symbols on one or more subcarriers in the subframe.

3. The method of claim 1, wherein transmitting the control information from the access node comprises transmitting the control information concurrently with the relay station transmitting a subframe without concurrently transmitting a common reference signal.

4. The method of claim 3, wherein transmitting the control information from the access node in the resource blocks allocated from the first portion of the subframe comprises transmitting the control information from the access node concurrently with the relay station bypassing transmission in the first portion of the subframe.

5. The method of claim 1, wherein transmitting the control information comprises transmitting a scheduling grant for transmission from the relay station to the access node.

6. The method of claim 5, comprising receiving acknowledgment feedback from the relay station in response to transmitting the control information comprising the scheduling grant, wherein the acknowledgment feedback is received on one of a plurality of uplink control channels that is indicated by a channel index.

7. The method of claim 6, wherein the channel index is predetermined, indicated by a value of a power control field transmitted by the access node, or a function of a physical resource block index and a control channel element corresponding to the scheduling grant.

8. The method of claim 1, comprising configuring the subframe using radio resource control signaling between the access node and the relay station.

9. A method, comprising:
conveying control information over a backhaul interface between an access node and a relay station concurrently with the relay station transmitting a subframe that does not include a common reference signal, wherein the control information is conveyed using resource blocks that are different than resource blocks allocated for transmission of control information by the relay station in the subframe.

10. The method of claim 9, wherein conveying the control information over the backhaul interface comprises conveying the control information in resource blocks allocated from a first portion of the subframe is different than a second portion of the subframe that comprises a selected number of symbols at the beginning of the subframe, wherein the second portion of the subframe is allocated for transmission of control information by the relay station.

11. The method of claim 10, wherein conveying the control information in the resource blocks allocated from the first portion of the subframe comprises conveying the control information over the backhaul interface concurrently with the relay station bypassing transmission in the first portion of the subframe.

12. The method of claim 9, comprising configuring the subframe for transmission from the access node to the relay station over the backhaul interface using radio resource control signaling between the access node and the relay station.

13. The method of claim 12, comprising configuring the subframe for transmission from the access node concurrently with the relay station configuring the subframe that does not include a common reference signal for transmission over an interface between the relay station and at least one access terminal.

14. A method, comprising:
generating, at an access node, control information including a scheduling grant in response to receiving a request from a relay station to transmit backhaul information associated with at least one access terminal;
configuring, at the access node, a first subframe for transmission of the control information concurrently with the relay station configuring a second subframe that does not include a common reference signal for transmission over an interface between the relay station and at least one access terminal; and
transmitting, from the access node, the first subframe concurrently with the relay station transmitting the second subframe, wherein resource blocks are allocated for the control information from a first portion of the first subframe that is different than a second portion of the second subframe allocated to a downlink control channel between the relay station and said at least one access terminal.

15. The method of claim 14, wherein the second portion of the second subframe comprises a selected number of symbols at the beginning of the second subframe, and wherein allocating resource blocks from the first portion of the first subframe comprises allocating symbols following the selected number of symbols on one or more subcarriers in the first subframe.

16. The method of claim 15, wherein transmitting the control information from the access node in the resource blocks allocated from the first portion of the first subframe comprises transmitting the control information from the access node concurrently with the relay station bypassing transmission in the first portion of the second subframe.

17. The method of claim 14, comprising receiving acknowledgment feedback from the relay station in response to transmitting the first subframe, wherein the acknowledgment feedback is received on one of a plurality of uplink control channels that is indicated by a channel index.

18. The method of claim 17, wherein the channel index is predetermined, indicated by a value of a power control field transmitted by the access node, or a function of a physical resource block index and a control channel element corresponding to the scheduling grant.

19. A method, comprising:
configuring, at a relay station, a first subframe that does not include a common reference signal for transmission over an interface between the relay station and at least one access terminal; and
transmitting, from the relay station, the first subframe concurrently with receiving a second subframe from an access node in response to the relay station transmitting a request to transmit backhaul information associated with said at least one access terminal, wherein transmitting the first subframe comprises bypassing transmission in resource blocks that are allocated for transmission of control information in the second subframe, the control information comprising a scheduling grant formed in response to the request to transmit backhaul information.

20. The method of claim 19, comprising transmitting, from the relay station, control information in a second portion of the first subframe that is allocated to a downlink control channel between the relay station and said at least one access terminal.

21. The method of claim 20, wherein the second portion comprises a selected number of symbols at the beginning of the first subframe, and wherein the resource blocks are allocated from symbols following the selected number of symbols on one or more subcarriers in the first subframe.

22. The method of claim 19, comprising attempting to decode the control information.

23. The method of claim 22, comprising transmitting acknowledgment feedback from the relay station indicating whether the attempt to decode the control information was successful, wherein the acknowledgment feedback is transmitted on one of a plurality of uplink control channels that is indicated by a channel index.

24. The method of claim 23, wherein the channel index is predetermined, indicated by a value of a power control field transmitted by the access node, or a function of a physical resource block index and a control channel element corresponding to the scheduling grant.
